(19) United States
(12) Patent Application Publication
(10) Pub. No.: US 2024/0420007 A1
(43) Pub. Date: Dec. 19, 2024

(54) TECHNIQUES FOR QUANTUM ERROR CORRECTION USING MULTIMODE GRID STATES AND RELATED SYSTEMS AND METHODS

(71) Applicant: Yale University, New Haven, CT (US)

(72) Inventor: Baptiste Royer, New Haven, CT (US)

(73) Assignee: Yale University, New Haven, CT (US)

(21) Appl. No.: 18/722,894

(22) PCT Filed: Dec. 21, 2022
(86) PCT No.: PCT/US2022/053675

§ 371 Date: Jun. 21, 2024

Related U.S. Application Data
(60) Provisional application No. 63/292,608, filed on Dec. 22, 2021.

(51) Int. Cl. G06N 10/70; G06N 10/40

(52) U.S. Cl. CPC G06N 10/70; G06N 10/40

(57) ABSTRACT

Techniques are described for implementing a class of multimode bosonic codes that protect against errors within an ancilla qubit coupled to a bosonic system, that can be realized experimentally. A logical qubit state is represented by the states of multiple different modes of one or more bosonic systems, which may include multiple modes of a single bosonic system and/or single modes from multiple bosonic systems. Techniques for correcting errors are also described. In particular, a series of operations are described that autonomously detect and correct errors by repeatedly performing a sequence of operations that are each applied to the multiple bosonic modes and/or to the ancilla qubit that is coupled to each of the bosonic modes. The codes allow ancilla errors to propagate to the modes of the bosonic system as correctable errors, where they can be corrected, instead of presenting as logical errors in the ancilla qubit.

### GOVERNMENT FUNDING

This invention was made with government support under W911NF-18-1-0212 awarded by United States Army Research Office. The government has certain rights in the invention.

### BACKGROUND

Quantum information processing techniques perform computations by manipulating one or more quantum objects. These techniques are sometimes referred to as “quantum computing.” In order to perform computations, a quantum information processor utilizes quantum objects to reliably store and retrieve information. According to some quantum information processing approaches, a quantum analogue to the classical computing “bit” (being equal to 1 or 0) has been developed, which is referred to as a quantum bit, or “qubit.” A qubit can be composed of any quantum system that has two distinct states (which may be thought of as 1 and 0 states), but also has the special property that the system can be placed into quantum superpositions and thereby exist in both of those states at once.

Several different types of qubits have been successfully demonstrated in the laboratory. However, the lifetime of the states of many of these systems before information is lost due to decoherence of the quantum state, or to other quantum noise, is currently around −100 μs for superconducting qubits. Notwithstanding longer lifetimes, it may be important to provide error correction techniques in quantum computing that enable reliable storage and retrieval of information stored in a quantum system. However, unlike a classical computing system in which bits can be copied for purposes of error correction, it is not possible to clone an unknown state of a quantum system. The system may, however, be entangled with other quantum systems which effectively spreads the information in the system out over several entangled objects.

### SUMMARY

A method of operating a circuit quantum electrodynamics system that includes an ancilla qubit dispersively coupled to a multimode bosonic system having a plurality of modes and operating as a logical qubit, the method comprising repeatedly performing a sequence of operations that autonomously detect and correct quantum errors arising in the state of the ancilla qubit and/or in the state of the logical qubit, the sequence of operations comprising applying a first drive waveform to each of the plurality of modes of the multimode bosonic system, wherein the first drive waveform changes the state of the ancilla qubit dependent on whether an error has occurred in the state of the ancilla qubit and/or in the state of the logical qubit, subsequent to applying the first drive waveform, applying a second drive waveform to the ancilla qubit, and subsequent to applying the second drive waveform, applying a third drive waveform to each of the plurality of modes of the multimode bosonic system, wherein the third drive waveform corrects the error that occurred in the state of the ancilla qubit and/or in the state of the logical qubit.

According to some embodiments, the sequence of operations further comprises applying a fourth drive waveform to each of the plurality of modes of the multimode bosonic system, wherein the fourth drive waveform changes the state of the ancilla qubit dependent on whether an error has occurred in the state of the ancilla qubit, subsequent to applying the fourth drive waveform, applying a fifth drive waveform to the ancilla qubit.

According to some embodiments, the sequence of operations further comprises applying a sixth drive waveform to the ancilla qubit to drive the ancilla qubit into an excited state.

According to some embodiments, the multimode bosonic system comprises a plurality of distinct bosonic systems each having one or more modes.

According to some embodiments, the multimode bosonic system comprises a single bosonic system having a plurality of modes.

According to some embodiments, the ancilla qubit is a transmon qubit.

According to some embodiments, the multimode bosonic system comprises two microwave cavities coupled to the ancilla qubit.

According to some embodiments, the sequence of operations autonomously detect and correct quantum errors arising in the state of the ancilla qubit, and the first drive waveform changes the state of the ancilla qubit dependent on whether an error has occurred in the state of the logical qubit.

According to some embodiments, the method further comprises performing a plurality of quantum gates on a logical state of the logical qubit.

According to some embodiments, the plurality of quantum gates are performed interleaved with instances of the sequence of operations, such that the method comprises at least performing a first quantum gate, followed by performing the sequence the operations a first time, followed by performing a second quantum gate, followed by performing the sequence of operations a second time.

According to some embodiments, the first drive waveform changes the state of the ancilla qubit by imparting a change of phase to the state of the ancilla qubit.

According to some embodiments, the first drive waveform further changes the state of one or more modes of the multimode bosonic system.

A system, comprising a circuit quantum electrodynamics system that includes an ancilla qubit dispersively coupled to a multimode bosonic system having a plurality of modes and operating as a logical qubit, at least one computer readable medium storing a plurality of drive waveforms, at least one controller configured to apply a first drive waveform of the plurality of waveforms to each of the plurality of modes of the multimode bosonic system, wherein the first drive waveform changes the state of the ancilla qubit dependent on whether an error has occurred in the state of the ancilla qubit, subsequent to applying the first drive waveform, apply a second drive waveform of the plurality of waveforms to the ancilla qubit, and subsequent to applying the second drive waveform, apply a third drive waveform of the plurality of waveforms to each of the plurality of modes of the multimode bosonic system, wherein the third drive waveform corrects the error that occurred in the state of the ancilla qubit.

According to some embodiments, the multimode bosonic system comprises a plurality of distinct bosonic systems each having one or more modes.

According to some embodiments, the multimode bosonic system comprises a single bosonic system having a plurality of modes.

According to some embodiments, the ancilla qubit is a transmon qubit.

According to some embodiments, the multimode bosonic system comprises two microwave cavities coupled to the ancilla qubit.

According to some embodiments, the at least one controller is further configured to apply a fourth drive waveform to each of the plurality of modes of the multimode bosonic system, wherein the fourth drive waveform changes the state of the ancilla qubit dependent on whether an error has occurred in the state of the ancilla qubit, subsequent to applying the fourth drive waveform, apply a fifth drive waveform to the ancilla qubit.

According to some embodiments, the at least one controller is further configured to apply a sixth drive waveform to the ancilla qubit to drive the ancilla qubit into an excited state.

According to some embodiments, the first drive waveform changes the state of the ancilla qubit by imparting a change of phase to the state of the ancilla qubit.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIGS. 1A-1B depict a process of encoding a logical quantum state in a bosonic system, according to some embodiments;

FIG. 2A depicts an illustrative system suitable for practicing aspects of the present application, according to some embodiments;

FIGS. 2B-2C depict different implementations of a logical qubit that is a multimode bosonic system, according to some embodiments;

FIG. 3 depicts an illustrative system that comprises a transmon ancilla qubit and a pair of resonator cavities, according to some embodiments;

FIG. 4 depicts a lattice of QEC grid states, according to some embodiments;

FIGS. 5A-5C depict aspects of a tesseract grid code, according to some embodiments;

FIG. 6A-6C depict illustrative examples of a dissipator circuit for quantum error correction, according to some embodiments;

FIG. 7A depicts the effect of translation errors in the tesseract code, according to some embodiments;

FIG. 7B depicts the logical error probability in the tesseract code, according to some embodiments;

FIGS. 8A-8E depict aspects of a D₄ grid code, according to some embodiments;

FIG. 9A depicts the effect of translation errors in the D₄ lattice code, according to some embodiments; and

FIG. 9B depicts the logical error probability in the D₄ lattice code.

### DETAILED DESCRIPTION

The present application relates to an improved quantum error correction technique for correcting errors in the state of a quantum system exhibiting one or more bosonic modes. An “error” in this context refers to a change in the state of the quantum system that may be caused by, for instance, boson losses, boson gains, dephasing, etc., and which alters the state of the system such that the information stored in the system can be altered.

As described above, quantum multi-level systems exhibit quantum states that, based on current experimental practices, decohere in short time periods (e.g., around ˜100 μs in superconducting qubits). While experimental techniques will undoubtedly improve on this and produce qubits with longer coherence times, it is nonetheless beneficial to store quantum information in another system that exhibits much longer coherence times. As will be described below, bosonic modes are particularly desirable for storing quantum information and thereby functioning as a ‘logical’ qubit. A logical qubit state may be represented by bosonic mode(s), thereby maintaining the same information yet in a longer-lived state than would otherwise exist in the physical multi-level system alone.

Quantum information stored in bosonic modes may nonetheless still have a limited lifetime, such that errors will still occur within the bosonic system. It may therefore be desirable to arrange a bosonic system to be robust against errors and/or to configure the bosonic system so that, when errors occur, the bosonic system can be driven to effectively correct those errors and regain the prior state of the system. If a broad class of errors can be corrected for, it may be possible to extend the coherence time of the bosonic system for long periods of time (and potentially indefinitely) by correcting for any type of error that might occur.

The fields of cavity quantum electrodynamics (cavity QED) and circuit QED represent one illustrative experimental approach to implement quantum error correction. In these approaches, a logical qubit state is mapped onto states of a resonator cavity. The resonator generally will have a longer stable lifetime than a physical qubit. If desired, the quantum state may later be retrieved in a physical qubit by mapping the state back from the resonator to the qubit.

When a multi-level system, such as a qubit, is mapped onto the state of a bosonic system to which it is coupled, a particular way to encode the qubit state in the bosonic states must be selected. This choice of encoding is often referred to as a “bosonic code,” or simply a “code.” As an example, a code might represent the ground state of a qubit using the zero boson number state of a resonator and represent the excited state of a qubit using the one boson number state of the resonator. That is:

$$( α \vert g 〉 + β \vert e 〉 ) ⊗ \vert 0 〉 \to \vert g 〉 ⊗ ( α \vert 0 〉 + β \vert 1 〉 )$$

where |g [symbol] is the ground state of the qubit, |e [symbol] is the excited state of the qubit, α and β are complex numbers representing the probability amplitude of the qubit being in state |g [symbol] or |e [symbol] , respectively, and |0 [symbol] and |1 [symbol] are the zero boson number state and one boson number state of the resonator, respectively. While this is a perfectly valid code, it fails to be robust against many errors, such as boson loss. That is, when a boson loss occurs, the state of the resonator prior to the boson loss may be unrecoverable with this code.

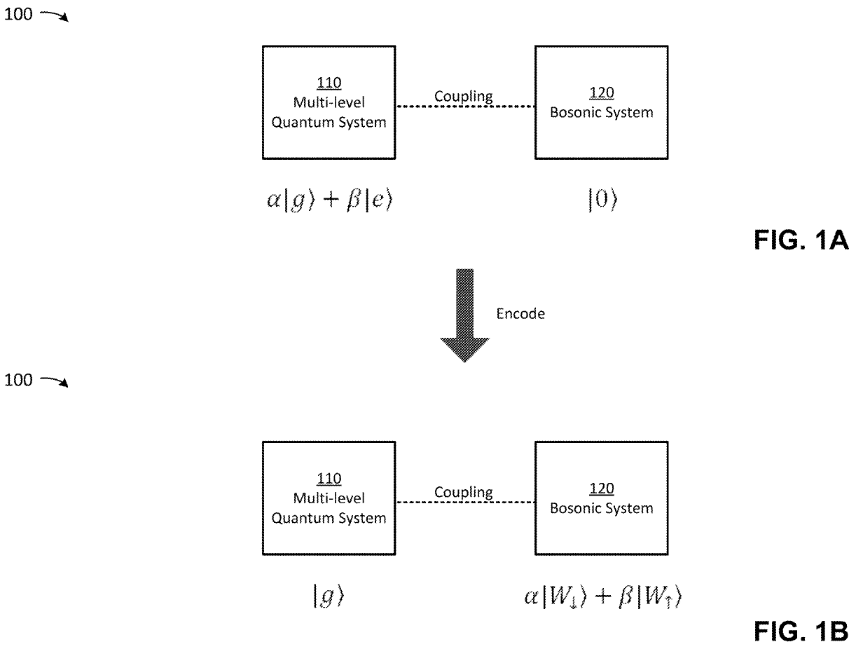

The use of a code can be written more generally as:

$$( α \vert g 〉 + β \vert e 〉 ) ⊗ \vert 0 〉 \to \vert g 〉 ⊗ ( α \vert {W}_{↓} 〉 + β \vert {W}_{↑} 〉 ) \qquad ( Eqn . 1 )$$

where |W↓ [symbol] and |W↑ [symbol] are referred to as the logical code words (or simply “code words”). The choice of a code—equivalently, the choice of how to encode the state of a two-level system (e.g., a qubit) in the state of the bosonic system—therefore includes choosing values for |W↓ [symbol] and |W↓ [symbol] . FIGS. 1A-1B graphically depict this process of encoding for some choice of |W↓ [symbol] and |W↑ [symbol] .

When an error occurs, the system's state transforms to a superposition of resulting states, herein termed “error words,” |E↓^{k} [symbol] and |E↑^{k} [symbol] as follows:

$$α \vert {W}_{↓} 〉 + β \vert {W}_{↑} 〉 \to α \vert {E}_{↓}^{k} 〉 + β \vert {E}_{↑}^{k} 〉 \qquad ( Eqn . 2 )$$

where the index k refers to a particular error that has occurred. As described above, examples of errors include boson loss, boson gain, dephasing, etc. In general, the choice of code affects how robust the system is to errors. That is, the code used determines to what extent a prior state can be faithfully recovered when an error occurs. A desirable code would be associated with a broad class of errors for which no information is lost when any of the errors occurs and any quantum superposition of the logical code words can be faithfully recovered.

One challenge with the above-described approach is that codes may be limited by the lifetime of a non-linear ancilla required for quantum control of the bosonic system. Typically the bosonic system is controlled, and errors in the bosonic system are corrected, through manipulation of an ancilla qubit that is coupled to the bosonic system. This may mean, however, that when an error occurs in the ancilla qubit, error correction of the state of the bosonic system may not longer be possible. While some attempts have been made to correct errors in ancilla qubits, some may require modification of the ancilla qubit, which is undesirable.

The inventors have recognized and appreciated a class of multimode codes that protect against errors within an ancilla qubit coupled to a bosonic system, and that can be realized experimentally. In these multimode codes, a logical qubit state is represented by the states of multiple different modes of one or more bosonic systems, which may include multiple modes of a single bosonic system and/or single modes from multiple bosonic systems. As such, irrespective of how the multimode system is practically implemented, a single logical qubit may be represented by the ensemble of bosonic modes. The inventors have further developed techniques for correcting errors when a multimode code is utilized to store a logical state in a multimode bosonic system. In particular, the inventors have developed a series of operations that autonomously detect and correct errors in the ancilla qubit by repeatedly cycling through a sequence of operations that are applied to the multiple bosonic modes and/or to an ancilla qubit that is coupled to each of the bosonic modes. The codes described herein allow ancilla errors to propagate to the modes of the bosonic system as correctable errors, where they can be corrected, instead of presenting as logical errors in the ancilla qubit.

According to some embodiments, the multimode codes described herein may be used to configure a state of a multimode bosonic system. Bosonic systems may be particularly desirable systems in which to apply the techniques described herein, as a single bosonic mode may exhibit equidistant spacing of coherent states. A resonator cavity, for example, is a simple harmonic oscillator with equidistant level spacing of bosonic modes. Bosonic modes are also helpful for quantum communications in that they can be stationary for quantum memories or for interacting with conventional qubits, or they can be propagating (“flying”) for quantum communication (e.g., they can be captured and released from resonators).

According to some embodiments, autonomous correction of errors in the ancilla qubit and/or in the multimode bosonic system may comprise repeating the same sequence of operations, wherein each operation applies a drive to either the modes of the multimode bosonic system, or to the ancilla qubit that is coupled to each of the modes of the multimode bosonic system. In some embodiments, the sequence of operations may comprise one or more drives applied to the modes of the multimode bosonic system that alter the state of the multimode bosonic system based on the state of the ancilla qubit (‘measurement drives’) and one or more drives applied to modes of the multimode bosonic system that correct errors in the ancilla qubit and/or the multimode state based on the state of the ancilla qubit. In some embodiments, the sequence of operations may comprise one or more drives applied to the ancilla qubit. In some embodiments, the sequence of operations may comprise: (1) a first drive (e.g., displacement drive) applied to the modes of the multimode bosonic system that alters the state of the multimode bosonic system based on the ancilla qubit state; (2) a first drive applied to the ancilla qubit; (3) a second drive (e.g., displacement drive) applied to the modes of the multimode bosonic system that alters the state of the multimode bosonic system based on the ancilla qubit state; (4) a second drive applied to the ancilla qubit; and (5) a drive (e.g., displacement drive) applied to the modes of the multimode bosonic system that corrects one or more errors in the ancilla qubit and/or the multimode state based on the state of the ancilla qubit. In some embodiments, a subsequent drive (6) may be applied to the ancilla qubit to set its state to the ground state, or to the excited state. In some embodiments, the above sequence operations may be preceded by application of an initialization drive to the ancilla qubit to set its state to the ground state, or to the excited state, or to a superposition of the ground and excited states.

According to some embodiments, autonomous correction of errors in the ancilla qubit and/or the multimode bosonic system may comprise repeating the drives (1)-(6) described above a number of times equal to twice the number of modes (2m) in the multimode bosonic system, wherein each of the m iterations of the drives (1)-(6) applies different drives to the modes of the multimode bosonic system in (1), (3) and (5). For example, a two mode multimode system may be controlled to autonomously correct errors by repeatedly performing a sequence of 24 drives with one sequence being performed after the previous sequence. Each of the drives (1)-(6) in each repetition of this sequence may be based on a different vector in phase space that defines the direction and length of displacement drives in (1), (3) and (5). The drives are derived from vectors s₁, s₂, s₃, . . . s₂ₘ described herein. As such, the first iteration of the sequence of the drives (1)-(6) may be based on a first vector s₁, a second iteration based on a second vector s₂, etc. through to the final iteration based on a vector s₂ₘ. Following this iteration, the entire sequence may then be repeated beginning with the first iteration again.

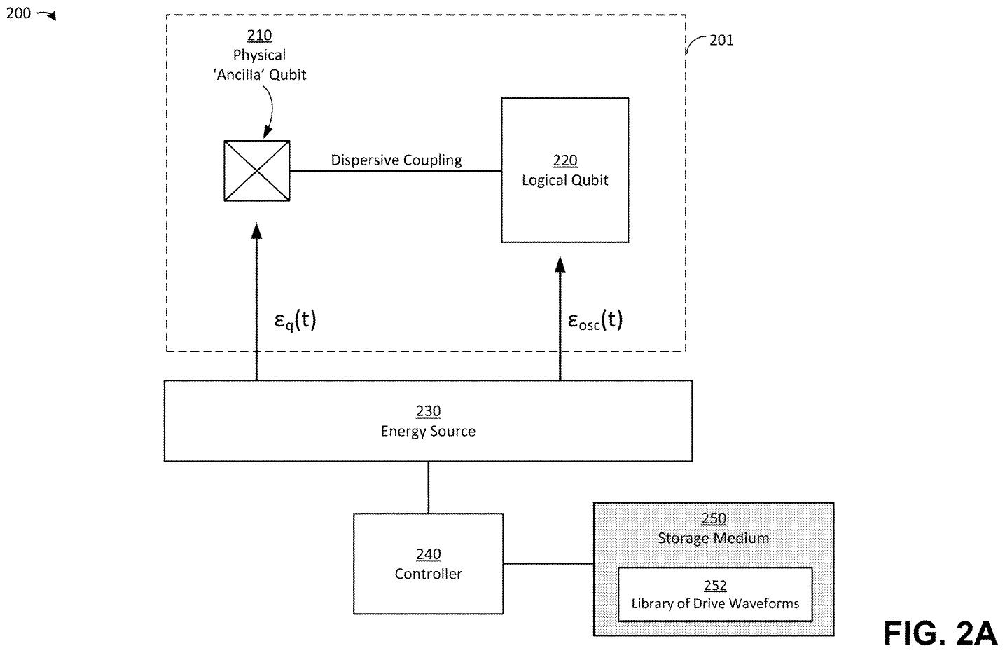

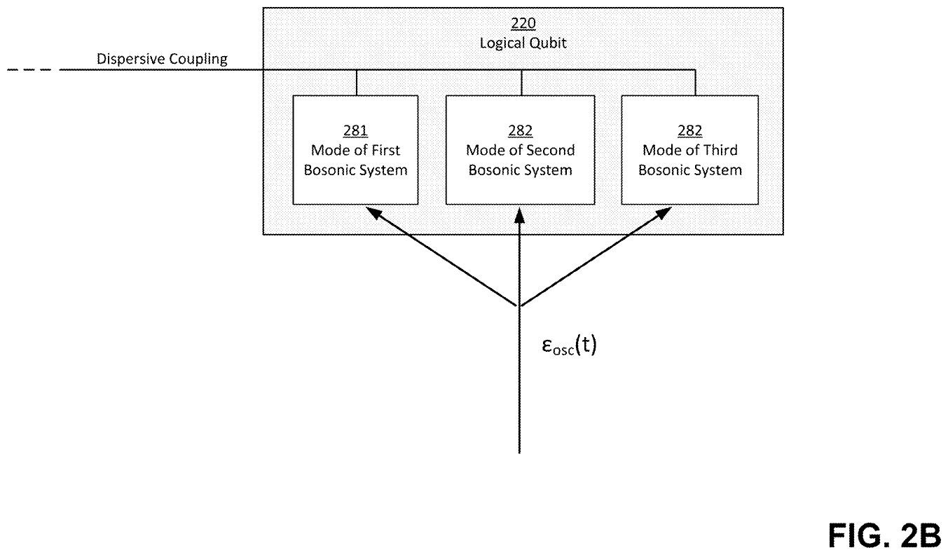

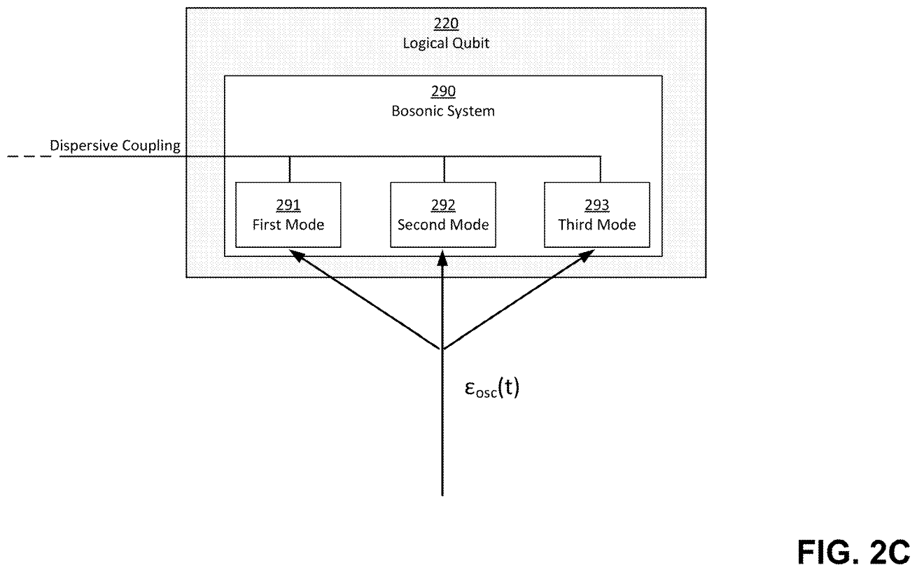

FIG. 2A depicts an illustrative system suitable for practicing aspects of the present application. In system 200, ancilla qubit 210 is coupled to a logical qubit 220 via dispersive coupling 215. Energy source 230 may supply energy to one or both of qubit 210 and logical qubit 220 in order to perform operations on the system such an encoding the state of the ancilla qubit 210 in the logical qubit 220, encoding the state of the logical qubit in the ancilla qubit, applying unitary operations to the logical qubit (e.g., to correct an error detected in the ancilla qubit and/or logical qubit), applying unitary operations to the ancilla qubit, or combinations thereof. In particular, an electromagnetic signal ε_{q}(t) may be applied to the physical qubit 210 and/or an electromagnetic signal ε_{osc}(t) may be applied to the logical qubit 220.

According to some embodiments, logical qubit 220 may be implemented as any suitable multimode bosonic system. While this may include photonic systems such as one or more microwave cavities, the techniques described herein are not limited to such systems. Logical qubit 220 may be implemented as a multimode bosonic system, which may include any combination of multiple modes of a single bosonic system and/or single modes of multiple bosonic systems. Examples are provided in FIGS. 2B and 2C, which show different implementations of logical qubit 220. In the example of FIG. 2B, the logical qubit is implemented as the ensemble of modes of three different bosonic systems. It may be noted that the drive ε_{osc}(t) is applied to each of the different modes at the same time. In the description above, where drives are described as being applied to modes of a multimode bosonic system it will be appreciated that this involves simultaneously applying a drive to all of the modes. This system of driving the modes may be distinct from a case in which multiple modes are separately driven and are treated as distinct logical qubits (e.g., in so-called concatenated codes). In the example of FIG. 2C, the logical qubit 220 is implemented as three different modes of a single bosonic system 290.

Returning to FIG. 2A, qubit 210 may include any suitable quantum system having at least two distinct states, such as but not limited to, those based on a superconducting Josephson junction such as a charge qubit (Cooper-pair box), flux qubit or phase qubit, transmon qubit, or combinations thereof. The ancilla qubit 210 may be coupled to the logical qubit 220 via dispersive coupling 215 which couples the state of the ancilla qubit to the state of the logical qubit. The logical qubit 220 may include any bosonic system supporting a plurality of bosonic modes, which may be implemented using any electromagnetic, mechanical, magnetic (e.g., quantized spin waves also known as magnons), and/or other techniques, such as but not limited to any cavity resonator (e.g., a microwave cavity). According to some embodiments, logical qubit 220 may comprise a plurality of transmission line resonators.

In the example of FIG. 2A, the ancilla qubit and logical qubit are dispersively coupled—that is, the ancilla qubit to logical qubit detuning is much larger (e.g., an order of magnitude larger) than the coupling strength between the ancilla qubit and the logical qubit.

System 200 includes system 201 (which comprises the ancilla qubit 210 and logical qubit 220) in addition to energy source 230, controller 240 and storage medium 250. In some embodiments, a library of precomputed drive waveforms may be stored on a computer readable storage medium and accessed in order to apply said waveforms to a quantum system. In the example of FIG. 2A, controller 240 accesses drive waveforms 252 stored on storage medium 250 (e.g., in response to user input provided to the controller) and controls the energy source 230 to apply drive waveforms ε_{q}(t) and ε_{osc}(t) to the ancilla qubit and logical qubit, respectively. In some cases, system 200 may comprise multiple instances of system 201, each of which may be driven by the same energy source, which is coupled to the same controller and storage medium. As such, a plurality of ancilla qubit and logical qubit pairings may be simultaneously driven and controlled by the elements 230, 240 and 250.

As used herein, application of such an electromagnetic signal or pulse may also be referred to as “driving” of the ancilla qubit and/or the logical qubit. Coupling 215 may utilize any technique(s) to couple the ancilla qubit and the logical qubit, such as by coupling electric and/or magnetic fields generated by the ancilla qubit and the logical qubit. According to some embodiments, the ancilla qubit (e.g., a transmon) may be coupled to the logical qubit, being a mechanical resonator, via a piezoelectric coupling. According to some embodiments, the ancilla qubit may be coupled to the logical qubit, being a magnetic resonator, by coupling the ancilla qubit (e.g., a transmon) to phonons, which in turn couple to magnons via magnetostrictive coupling.

While examples of a superconducting qubits have been provided herein, it will be appreciated that the techniques described herein may be applied to other suitable systems, including but not limited to trapped ion qubits. For instance, electronic levels of trapped ions may be used as an ancilla qubit.

In general, system 200 may be operated so that a sequence of drives ε_{q}(t) and ε_{osc}(t) are applied to the ancilla qubit and logical qubit in an error correction sequence. In each step of the error correction sequence, either or both of the drives may be operated. The sequence of drives may be selected based on the particular code being used to store the logical state of the logical qubit. Examples of suitable codes and illustrative error correction sequences are described below.

According to some embodiments, drives ε_{q}(t) and/or ε_{osc}(t) may be applied to the ancilla qubit and logical qubit to perform one or more operations that alter the logical state of the logical qubit. These operations may include, for example, state preparation, logical gates, readout operations, etc. Gate operations may include single qubit gates, as well as multiple-qubit gates in which multiple instances of the logical qubit and ancilla qubit elements are driven. Error correction sequences may, in some embodiments, be performed interleaved with such operations. For instance, system 201 may be driven to prepare a state, then an error correction sequence performed, then a single qubit gate may be applied to the system, then the error correction sequence may be performed, etc.

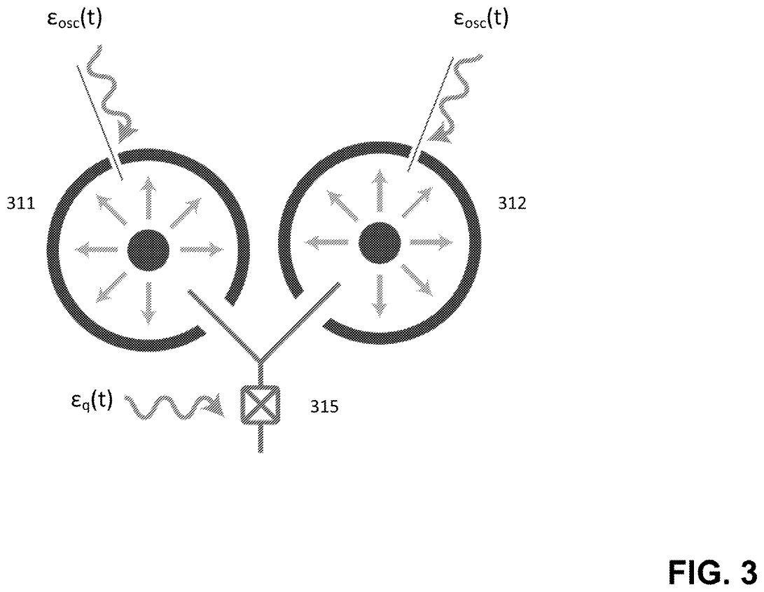

FIG. 3 depicts an illustrative implementation of system 201 that comprises a transmon ancilla qubit and a pair of resonator cavities, according to some embodiments. In the example of FIG. 3, resonator cavities (e.g., microwave cavities) 311 and 312 are both dispersively coupled to a transmon qubit 315, which acts as an ancilla qubit. The resonator cavities 311 and 312 are operated as a single logical qubit using the resonator mode of the first resonator cavity 311 and the resonator mode of the second resonator cavity 312 as multiple modes for purposes of storing logical quantum information. For instance, the system of FIG. 3 is an example of using two bosonic systems as a logical qubit as shown in FIG. 2B (albeit with two bosonic systems instead of the three shown in FIG. 2B). In the example of FIG. 3, electromagnetic modes of the resonator cavities and the transmon qubit may be controlled by drives ε_{q}(t) and/or ε_{osc}(t).

Prior to describing the various multimode codes that may be employed as described herein, the notation and conventions that will be followed herein are first described. In the following, m harmonic oscillator (resonator) modes are considered to establish correspondences between translations in a (symplectic) vector space [symbol] ^{2m} and the quantum Hilbert space of these m modes. The dimensionless creation and annihilation operators for the jth mode are denoted âⱼ and âⱼ^{†}, respectively, obeying [âⱼ,âₖ^{†}]=δⱼₖ. The below assumes units of ℏ=1 and denotes the quadrature coordinates \hat{q}ⱼ=(âⱼ+âⱼ^{†})/\sqrt{2} and \hat{p}ⱼ=−i(âⱼ−âⱼ^{†})/\sqrt{2} such that [\hat{q}ⱼ,\hat{p}ₖ]=iδⱼₖ. The quadrature coordinates are arranged in vectors such that \hat{x}=(\hat{q}₁, \hat{p}₁, \hat{q}₂, . . . , \hat{q}_{M}, \hat{p}ₘ), and points in phase space correspond to vectors v∈ [symbol] ^{2m} arranged in the same order as \hat{x}. All quantum operators are decorated with a hat and vectors are denoted by bold font.

A translation in phase space of the bosonic modes in defined by v in units of l=\sqrt{2π} as

$$T ( v ) ≡ {e}^{- il {\hat{x}}^{T} Ω v} = {⊗}_{j = 1}^{m} {\hat{D}}_{j} ( {l [ Cv ]}_{j} ) ,$$

where \hat{D}ⱼ(α)=exp{α\hat{α}ⱼ^{†}−α*\hat{α}ⱼ} with α∈ [symbol] is the standard displacement operator for the jth mode and C is a m×2m matrix that maps the real vector v∈ [symbol] ^{2m} to a complex vector Cv∈∈ [symbol] ^{m},

$$C = \frac{1}{\sqrt{2}} ( \begin{matrix}1 & i & 0 & 0 & … \\ 0 & 0 & 1 & i & … \\ & & … & & \end{matrix} ) .$$

The anti-symmetric matrix

$$Ω = {⊕}_{m} ( \begin{matrix}0 & 1 \\ - 1 & 0\end{matrix} ) ,$$

is also defined, from which the symplectic form

ω(u,v)=u^{T}Ωv.

is defined. This form is alternating, ω(u,v)=−ω(v,u), which implies that ω(u,u)=0. The commutation relations of the quadrature coordinates impose that

$$\hat{T} ( u ) \hat{T} ( v ) = \hat{T} ( v ) \hat{T} ( u ) {e}^{i 2 π {v}^{T} Ω u} = \hat{T} ( u + v ) {e}^{i π {v}^{T} Ω u} .$$

By defining translations in units of l=\sqrt{2π}, the translation operators associated with two vectors u and v commute if and only if their symplectic form is an integer, [\hat{T}(u),\hat{T}(v)]=0⇔u^{T}Ωv∈ [symbol] .

Define a rotation of the jth bosonic mode

$${\hat{R}}_{j} ( θ ) = {e}^{- i θ {\hat{n}}_{j}} ,$$

with \hat{n}ⱼ=âⱼ^{†}âⱼ, and its associated symplectic representation

$$R ( θ ) = ( \begin{matrix}cos θ & - sin θ \\ sin θ & cos θ\end{matrix} ) ,$$

with \hat{R}(θ)=\hat{Q}[R(θ)]. Moreover, also define a beamsplitter operation between two modes j, k, \hat{B}_{j→k}=exp{−iπ(\hat{q}ⱼ\hat{p}ₖ−\hat{p}ⱼ\hat{q}ₖ)/4} which has a symplectic representation

$${B}_{j \to k} = \frac{1}{\sqrt{2}} ( \begin{matrix}1 & 0 & - 1 & 0 \\ 0 & 1 & 0 & - 1 \\ 1 & 0 & 1 & 0 \\ 0 & 1 & 0 & 1\end{matrix} ) .$$

The arrow in the graphical representation of the beamsplitter operation matches the direction of the j→k arrow.

Finally, denote logical operations acting on encoded qubits with an overhead bar, G̅, and denote the corresponding multimode unitary as Û(G̅). As is usual for error-correcting codes, logical gates can have multiple equivalent representatives, and as a result the mapping Û(G̅) is not unique. The representative referred to with the mapping Û will be clear from the context.

The translations \hat{T}(v) and rotations \hat{R}ⱼ(θ) described above play a central role in quantum error correction of the multi-dimensional grid states, as described below. Initially, however, the states themselves are described below.

### General Theory of Multi-Dimensional Grid States

According to some embodiments, the techniques described herein may encode a logical qubit in translation-invariant grid states, described below. In some cases, a logical qudit may be encoded in such state (a qudit is a quantum digit, and may have 2 or more values; a qubit is an example of a qudit with 2 values). Taking m oscillator modes, a Quantum Error Correction (QEC) code may be associated with a (classical) lattice Λ in 2m dimensions, each mode contributing two quadrature coordinates, \hat{q} and \hat{p}. The lattice Λ is generated by a set of 2m linearly independent translations {sⱼ}, which can be arranged in a 2m×2m matrix S where each row corresponds to one basis vector sⱼ,

$$S = ( \begin{matrix}{s}_{1} \\ {s}_{2} \\ … \\ {s}_{2 m}\end{matrix} ) .$$

The lattice points are then given by

$$Λ = \{ {S}^{T} a \vert a ∈ {ℤ}^{2 m} \} .$$

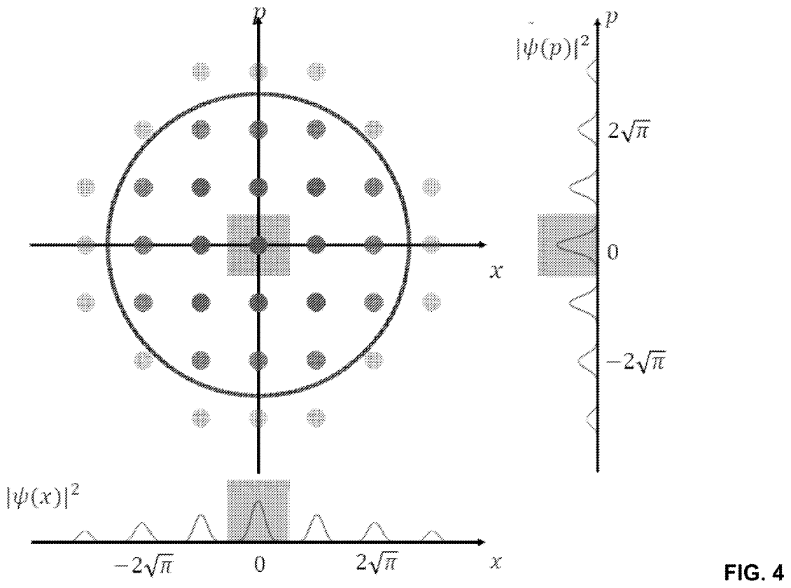

An example of a lattice is shown in FIG. 4, which depicts lattice points in phase space (the diagram is labeled in terms of x and p as coordinates, rather than \hat{q} and \hat{p} as in the description herein; however, these are the same quantities and differ only in notation). The different code words of the QEC grid code are represented by the filled circles.

The QEC grid code is defined by associating each generator of the lattice with a generator of the stabilizer group, sⱼ→\hat{T}(sⱼ). The (infinite) stabilizer group is then given by

$$𝒮 = \{ {\prod }_{j = 1}^{2 m} {\hat{T} ( {s}_{j} )}^{{a}_{j}} \vert a ∈ {ℤ}^{2 m} \} ,$$

with each stabilizer associated with a point on the lattice Λ. QEC grid code words are defined to be in the simultaneous +1 eigenspace of all stabilizers.

The generators of the quantum translation, \hat{T}, associated with the generators of the stabilizer group are given by

$$\hat{g} = - lS Ω \hat{x} ,$$

such that the jth generator of the stabilizer group is given by \hat{T}(sⱼ)=exp{iĝⱼ}. Measuring the stabilizer \hat{T}(sⱼ) is equivalent to measuring the modular quadrature coordinate ĝⱼ mod 2π, and in particular eigenstates of \hat{T}(sⱼ) are also eigenstates of ĝⱼ.

The stabilizers of the QEC grid code have a continuous spectrum. Restricting the code space to the +1 eigenspace of the stabilizers thus imposes an infinite amount of constraints, restricting the eigenvalues of ĝⱼ to be within the countable set gⱼ=0 mod 2π within the uncountable eigenstates with eigenvalues gⱼ∈ [symbol] . The intersection of the +1 eigenspace of each stabilizer is a finite dimensional space, with a dimension d specified below. Quadrature coordinate eigenstates are equivalent to infinitely squeezed states which contain an infinite amount of energy, making the code words unphysical. As a result a realistic, finite-energy version of the code words stabilizer group [symbol] is described below.

The symplectic Gram matrix of the lattice Λ, setting the pairwise commutation relations of the stabilizer generators, is given by

A=SΩS^{T},

such that \hat{T}(sⱼ)\hat{T}(sₖ)=\hat{T}(sₖ)\hat{T}(sⱼ)e^{2πiA}^{ⱼₖ}. In order for the stabilizers to commute with each other, Λ should be symplectically integral, meaning that A should only contain integers.

Associated with the lattice Λ, the symplectic dual lattice Λ* is defined as the ensemble of points that have an integer symplectic form with the lattice points Λ,

$${Λ}^{*} = \{ v \vert S Ω v ∈ {ℤ}^{2 m} \} \qquad ( Eqn . 1 )$$

Henceforth, Λ* is referred to as the dual lattice instead of the more precise term symplectic dual lattice. Since the lattice is symplectically integral, the definition of Λ* implies that Λ⊆Λ*. One choice of generator matrix for the dual lattice Λ* is obtained from:

$${S}^{*} = {A}^{- 1} S .$$

Associating a translation to each point in the dual lattice, Eqn. 1 implies that the set of translation operators {\hat{T}(λ*)|λ*∈Λ*} forms (modulo phases) the centralizer of [symbol] in the group of translations, i.e. corresponds to all translations that commute with all elements of the stabilizer group. In a QEC code, logical operators correspond to operators that leave the stabilizer group invariant. Here, all translations are associated with a logical Pauli operator by a dual lattice vector. Since translations that differ by a lattice vector are equivalent in the logical subspace, the logical information is encoded in the dual quotient group Λ*/Λ and the number of distinct logical operators is given by the number of dual lattice points inside the fundamental parallelotope of Λ. Put another way, the number of distinct logical operators is given by the ratio of volumes between the fundamental parallelotope of the base and dual lattices. Defining the determinant of a lattice to be det(Λ)=det(A), the condition to encode a d-level qudit with d² logical Pauli operators is that

det(Λ)=d².

To investigate multimode codes, it is desirable to search for codes that can be obtained by scaling the lattice size by a constant c∈ [symbol] , starting with a symplectically integral lattice Λ. Importantly, the condition that the translations {\hat{T}(sⱼ)} commute imposes constraints on the attainable code dimension d. The determinant of the lattice, which sets the code dimension, scales as

$$det ( c Λ ) = {c}^{4 m} det ( Λ ) \qquad ( Eqn . 2 )$$

On the other hand, the symplectic Gram matrix, which sets the commutation relations of the stabilizers, scales as

$$A ( c Λ ) = {c}^{2} A ( Λ ) \qquad ( Eqn . 3 )$$

In other words, the code dimension scales as a volume, while the commutation relations between the stabilizers scale as an area. Note that the single-mode case is special since area and volume coincide, and scaling a single-mode lattice by any constant c=\sqrt{a} with a∈ [symbol] an integer results in a valid code. However, multimode (m≥2) QEC grid codes are more constrained than their single-mode counterpart since the conditions given by Eqns. 2 and 3 do not coincide.

Denote Λ₀ the smallest integral lattice that can be built by scaling Λ, and denote the associated symplectic Gram matrix A₀. Under the scaling by c, the elements of A should remain integers, which imposes the constraint that c²=a∈ [symbol] be an integer. Combining with Eqn. 2, it may be shown that a lattice Λ₀ allows for codes of dimension

$$d = {a}^{m} det ( {S}_{0} ) \qquad ( Eqn . 4 )$$

In particular, if det(S₀)=1 such that the lattice encodes a single logical state, scaling the size of the lattice allows to encode ensembles of m qudits of dimension a. For a single-mode two-dimensional lattice, the lattice can be rescaled such that det(Λ₀)=1, and since m=1 all code dimensions are possible.

While scaling a lattice provides for codes out of known symplectically integral lattices, it is not the only allowed operation. Consider the basis S′=SO where O∈O( [symbol] , 2m)−Sp( [symbol] , 2m) is orthogonal but not symplectic. For example, a two-mode rotation in the quadrature coordinates \hat{q}₁, \hat{q}₂ that leaves their conjugate coordinates \hat{p}₁, \hat{p}₂ invariant is orthogonal but not symplectic. With respect to the Euclidean norm, S and S′ are bases for two equivalent lattices, SS^{T}=S′S′^{T}, but the symplectic Gram matrix associated with these bases are not the same, SΩS^{T}≠S′ΩS′^{T}. This means that for a general basis S where A=SΩS^{T} is not integral, there can be an orthogonal transformation such that A′=S′ΩS′^{T} is integral. In other words, viewing the symplectic form as a sum of areas, there can be special “rotations” of the lattice where these areas add up to integers for each pair of stabilizers. To search for codes that do not respect Eqn. 4, the strategy described herein is to scale a lattice to the desired volume, and then search for an orthogonal transformation O such that A′ is integral. Note that once a solution is found using this procedure, say for dimension d′, then all solutions of dimension d′a^{m} are also valid per Eqn. 4.

The techniques described herein primarily focus on encoding a qubit d=2 in multiple modes. Each vector of the dual lattice Λ* is associated with a logical Pauli operator P̅, P̅∈{X̅, Y̅, Z̅}. For each logical Pauli operator P̅, choose a base representative p₀ such that any translation by p with T̅(p)=Ū(p) is expressed as p=p₀+λ for some λ∈Λ. Define the set of points P=p₀+Λ. Define a 3×2m matrix where each row sets one of these base representatives

$${L}_{0} = ( \begin{matrix}{x}_{0} \\ {y}_{0} \\ {z}_{0}\end{matrix} ) , \qquad ( Eqn . 5 )$$

with x₀, y₀ and z₀ associated with the logical Pauli operators X̅, Y̅ and Z̅, respectively. Without loss of generality, choose the representatives of minimum length with respect to the Euclidean norm for each Pauli operator, such that T̅(p)=Ū(P̅)⇒|p|≥|p₀|. The logical identity operator is omitted from Eqn. 5, since it corresponds to the stabilizers with the trivial base representative 0.

The following may also make use of grid codes encoding a single state, d=1. Such codes may be referred to as “qunaught” states since they carry no quantum information, and are labeled with a subscript ø. The single-mode square qunaught state is sometimes referred to as a sensor state since it can be used to precisely measure translations in two conjugate quadrature coordinates simultaneously.

### Finite-Energy Multimode OEC Grid States

The previous section considered grid states that extend infinitely in phase space. In other words, the eigenstates of translation operators are superpositions of infinitely squeezed states containing an infinite amount of energy.

In this section, finite-energy QEC grid code states are considered that are obtained by taking a m-mode envelope of the form

$${\hat{E}}_{β} = exp ( - {\sum }_{j = 1}^{m} {β}_{j} {\hat{n}}_{j} ) , \qquad ( Eqn . 5 )$$

where βⱼ parametrizes the extent of the QEC grid mode states in the jth mode. This envelope can be interpreted as the multiplication of the grid state by the density matrix of a m-mode thermal state, motivating the notation choice “β”. Alternatively, Eqn. 5 can be interpreted as a gaussian envelope in phase space since \hat{n}ⱼ=(\hat{q}ⱼ²+\hat{p}ⱼ²+1)/2.

The finite-energy logical code words ψ̅=0,1 are then defined as

$$\vert {\overline{ψ}}_{β} 〉 = {𝒩}_{ψ , β} {\hat{E}}_{β} \vert {\overline{ψ}}_{0} 〉 ,$$

with [symbol] _{ψ,β} a normalization constant and |ψ̅₀ [symbol] the ideal, infinite-energy code words.

Define finite-energy stabilizers from the similarity transformation induced by the envelope,

$$\begin{matrix}{\hat{T}}_{j , β} = {\hat{E}}_{β} \hat{T} ( {s}_{j} ) {\hat{E}}_{β}^{- 1} , \\ = exp \{ i {\hat{E}}_{β} {\hat{g}}_{j} {\hat{E}}_{β}^{- 1} \} .\end{matrix}$$

Finite-energy code words are exact +1 eigenstates of these operators, \hat{T}_{j,β}| [symbol] =|ψ̅_{β} [symbol] . Based on ĝ=−lSΩ\hat{x}, the generators of translations of the stabilizer group transform to

$${\hat{E}}_{β} \hat{g} {\hat{E}}_{β}^{- 1} = - lS Ω \{ cosh [ Diag ( β ) ] + i sinh [ Diag ( β ) ] Ω \} \hat{x} ,$$

where the 2m-dimensional vector β=(β₁, β₂, . . . βₘ) [symbol] (1,1) and Diag correspond to the operation of building a diagonal matrix from a vector. In the limit β→0, the translation operators, \hat{T}_{j,0}=\hat{T}(sⱼ) may be recovered.

Returning to FIG. 4, an illustrative finite envelope is shown over the depicted grid states by the circular region centered over the origin. The states within this envelope may therefore be considered finite-energy QEC grid code states, as represented in the drawing by the darker shading for these states.

In the remaining description below, a homogeneous envelope size βⱼ=β is considered for all j, such that Ê_{β}=exp(−β\hat{n}), with \hat{n}=Σⱼ\hat{n}ⱼ the total excitation number. For this choice, operations that commute with \hat{n} also commute with the envelope, and such operations may be referred to herein as envelope-preserving. Gaussian operations in that category, \hat{Q}(O) with O∈Sp(2m, [symbol] )∩O(2m, [symbol] ), can be implemented by a combination of beam-splitters and phase shifters, e.g., passive linear optics. Envelope-preserving gates also include non-linear gates such as the unitaries generated by Kerr and cross-Kerr interactions. Importantly, envelope-preserving operations are exact for finite-energy QEC grid codes.

Taking the logarithm of the stabilizers \hat{T}_{j,β}, and in analogy with continuous-variable cluster states, define the finite-energy nullifiers of the code

$${\hat{d}}_{j} = ( \frac{[ {s}_{j}^{T} Ω \hat{x} mod l / cosh β ]}{\sqrt{2 \vert {s}_{j} \vert tanh ( β )}} - i \sqrt{\frac{tanh ( β )}{2 \vert {s}_{j} \vert}} {s}_{j}^{T} \cdot \hat{x} ) \qquad ( Eqn . 6 )$$

The finite-energy code words are then also defined by \hat{d}ⱼ|ψ̅_{β} [symbol] ≈0∀j. Without the modular part of the first term, \hat{d}ⱼ corresponds to the nullifier of a finitely squeezed state.

### Gauge Choices

As demonstrated by:

$$Λ = \{ {S}^{T} a \vert a ∈ {ℤ}^{2 m} \}$$

$$𝒮 = \{ {\prod }_{j = 1}^{2 m} {\hat{T} ( {s}_{j} )}^{{a}_{j}} \vert a ∈ {ℤ}^{2 m} \} ,$$

the points of the lattice Λ are in one-to-one correspondence with the elements of the stabilizer group [symbol] . However, λ∈Λ does not imply that \hat{T}(λ)∈ [symbol] , and the correspondence between elements of Λ and [symbol] requires an additional phase.

For example, take two stabilizers \hat{T}(s₁) and \hat{T}(s₂) commuting by 2π, such that s₁^{T}Ωs₂=1. Following the relationship for \hat{T}(u)\hat{T}(v), \hat{T}(s₁+s₂)|ψ [symbol] =−\hat{T}(s₁)\hat{T}(s₂)|ψ [symbol] =−|ψ [symbol] , for all logical code words |ψ [symbol] . Within the lattice points Λ, it is therefore possible to distinguish between two subsets Λ_{±}⊆Λ such that, for states |ψ [symbol] in the code space,

$${Λ}_{v} = \{ λ ∈ Λ \vert \hat{T} ( λ ) \vert ψ 〉 = v \vert ψ 〉 \} ,$$

with v=±. For example, for the single-mode square qunaught state with generator matrix S_{ø}= [symbol] ₂, the generator vectors are s₁, s₂ ∈Λ₊, while their sum s₁+s₂=(1; 1)∈Λ₋. For a qubit encoded in a single-mode, all lattice vectors associated with the stabilizer group necessarily belong to Λ₊ since there are only two generators and the dimension condition imposes that |s₁^{T}Ωs₂|=2.

It may be useful to allow different gauge choices μ∈ [symbol] ₂^{2m} such that for the generators of the stabilizer group \hat{T}(s)|ψ [symbol] =(−1)^{μ}^{ⱼ}|ψ [symbol] for states |ψ [symbol] in the code space. The stabilizer group is correspondingly updated to

$${𝒮}_{μ} = \{ {\prod }_{j = 1}^{2 m} {[ {( - 1 )}^{{μ}_{j}} \hat{T} ( {s}_{j} ) ]}^{{a}_{j}} \vert a ∈ {ℤ}^{2 m} \} ,$$

Different choices for S or μ can lead to different subsets Λ_{±} for the same base lattice Λ.

Defining A_{Δ} as the lower triangular part of the symplectic Gram matrix A=SΩS^{T}, the lattice vectors λ∈Λ may be classified according to the gauge μ:

$${v}_{μ} ( λ ) = exp \{ i π {λ}^{T} {S}^{- 1} [ {( {S}^{- 1} )}^{T} λ + μ ] \}$$

Since Λ is symplectically integral, v_{μ}(λ)∈{±1}. Moreover, if λ∈Λᵥ, then its inverse is also in the same set, −λ∈Λᵥ.

In a similar fashion to the stabilizer gauge μ, define a gauge for the logical Pauli operators υ∈ [symbol] ₂³, which is equivalent to a so-called Pauli frame. Accordingly, define the eigenstate of the logical Pauli operator P̅ such that (−1)^{v}^{ₚ}\hat{T}(p₀)|ψ_{+P} [symbol] =|ψ_{+P} [symbol] . One of the three elements of u is redundant, as the gauge is fully set by υₓ and υ_{z}. Here all three elements may be kept for convenience. In a similar manner to the lattice vector subsets Λ_{±}, define the subsets P_{±} for each Pauli operator P∈{X, Y, Z} as

$${P}_{v} = \{ p ∈ P \vert \hat{T} ( p ) \vert {ψ}_{+ P} 〉 = v \vert {ψ}_{+ P} 〉 \} ,$$

which depends on the stabilizer gauge μ, the Pauli frame gauge υ and the base representatives {p₀}. The sign associated with a particular vector p∈P is computed using

$${v}_{μ , υ}^{P} ( p ) = {e}^{i π [ {p}_{0}^{T} Ωp + {υ}_{p} ]} {v}_{μ} ( p - {p}_{0} ) ,$$

and logical Pauli operators are given by

Û(P̅)=v_{μ,v}^{P}(p)\hat{T}(p)

for all p∈P=p₀+Λ.

In order for the Pauli eigenstates |ψ_{±P} [symbol] to have eigenvalue ±1, note that v_{μ}(2p₀) should equal 1, where 2p₀∈Λ by construction. Indeed, the eigenvalues of translations by \hat{T}(p₀) are constrained to be \sqrt{v_{μ}(2p₀)}, such that v_{μ}(2p₀)=−1 implies that \hat{T}(p₀)|ψ [symbol] =±i|ψ [symbol] . To constrain the eigenvalues of the Pauli operators to be real, add the condition that

$$2 {A}^{- 1} μ mod 2 = 0 .$$

This condition is respected in the trivial gauge μ=0, and in the special case of a single-mode QEC grid code qubit, this is the only gauge respecting this condition. However, for multimode lattices, there are multiple gauges allowed.

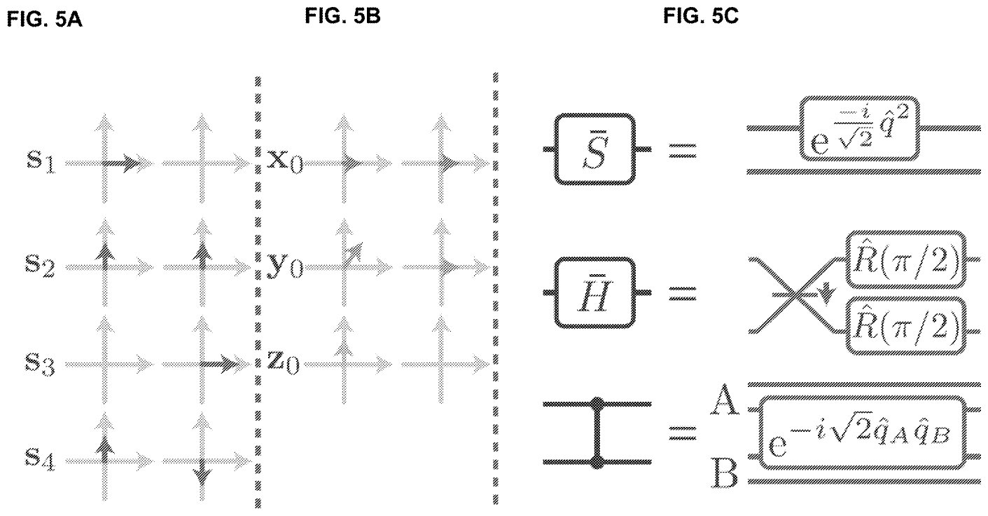

As an example of the most salient aspects of the above-described QEC grid codes, FIGS. 5A-5C depicts the stabilizer generators and logical operators, as well as example qubit manipulations, for one choice of lattice codes referred to herein as the ‘tesseract code.’ In the example of FIG. 5A the stabilizer generators sⱼ, which are comprised of the set s₁, s₂, s₃ and s₄, are depicted. These stabilizer generators are of equal length and are orthogonal to one another. To perform quantum error correction, dissipation circuits are applied to the multimode system, with a dissipation circuit performed for each stabilizer generator. The tesseract code is an example of a two-mode code, and so has four stabilizer generators. FIG. 5A depicts the projection onto the (q,p) phase space of the first and second modes (i.e., s₁ is the projection of the first mode onto q, s₂ is the projection of the first mode onto p, s₃ is the projection of the second mode onto q, s₄ is the projection of the second mode onto p.) FIG. 5B depicts the logical operators (the operators that leave the stabilizer group invariant) and FIG. 5C depicts implementations of logical Clifford gates given the code space described by the tesseract code. The tesseract code is described in further detail below, but introduced here to provide context for the below discussion of quantum error correction using a given lattice code.

### Quantum Error Correction

In this section, an error correction strategy for the system of FIG. 2A is described. The error correction strategy is based on engineering an ensemble of 2m dissipators,

$$\dot{ρ} = {\sum }_{j = 1}^{2 m} D [ {\hat{d}}_{j} ] ρ \qquad ( Eqn . 7 )$$

where [symbol] [ô]⋅=ô⋅ô^{†}−{ô^{†}ô,⋅}/2 is the dissipation superoperator and ρ is the multimode state encoding the logical quantum information. This strategy relies on the fact that the steady state of the master equation above is given by \hat{d}ⱼ|ψ [symbol] =0 for all j, which precisely corresponds to the code space.

Instead of implementing directly the continuous dissipators of Eqn. 7, the oscillators-bath interaction is discretized, and the baths replaced by a single qubit that is frequently reset. This can be achieved through repeated oscillators-bath interactions of the form

$${\hat{U}}_{stab}^{( j )} = {e}^{- i \sqrt{{Γ}_{j}} ( {\hat{d}}_{j} {σ}_{-} + {\hat{d}}_{j}^{†} {σ}_{+} )}$$

where Γⱼ is an effective (dimensionless) cooling rate. Resetting the ancilla qubit to its ground state |g [symbol] and repeating this interaction, the entropy from the oscillators is removed in such a way as to cool the system towards the +1 eigenspace of the exact \hat{T}_{j,β} stabilizer of the finite-energy QEC grid code. One interaction and reset cycle may be referred to as a dissipation round, and the full code space is stabilized by alternating dissipation rounds for each of the 2m stabilizer generators \hat{T}_{j,β}.

Since an m-mode code has 2m stabilizer generators, a combination of at least 2m dissipation circuits are applied (with one dissipation circuit being applied in each dissipation round). In some embodiments, however, more than 2m dissipation circuits could be applied, which may be desirable especially for lattices which have more than 2m lattice vectors of minimum length (counting once a vector and its inverse).

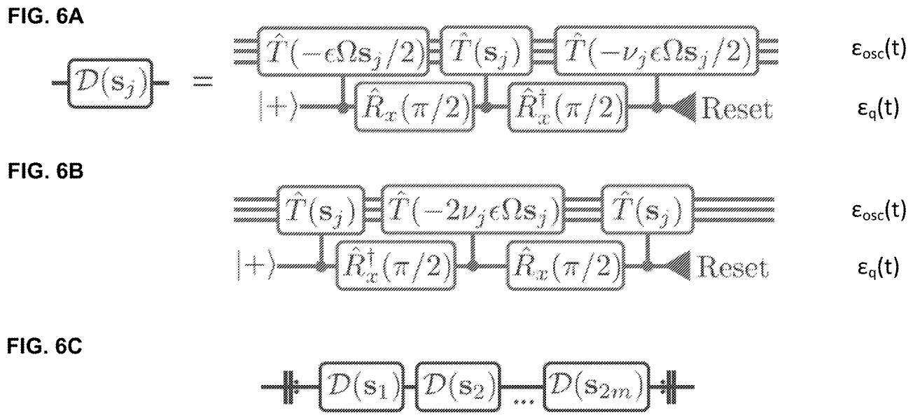

FIG. 6A-6B depict illustrative examples of a dissipator circuit for quantum error correction, according to some embodiments. In practice, the dissipator circuit [symbol] (sⱼ) depicted in FIG. 6A or FIG. 6B is performed 2m times for each stabilizer generator sⱼ=s₁, s₂, . . . s₂ₘ, as shown in FIG. 6C. FIGS. 6A and 6B represent two different illustrative dissipator circuits, which are described above.

The dissipator circuit includes two horizontal sections, with the upper section indicating drives ε_{osc}(t) applied to the bosonic modes, and the lower section indicating drives ε_{q}(t) applied to the ancilla qubit. For instance, the dissipators of FIGS. 6A and 6B each depicts a first multimode translation \hat{T} applied to the bosonic modes, followed by a rotation \hat{R}ₓ applied to the qubit, followed by a second multimode translation \hat{T} applied to the bosonic modes, followed by a rotation \hat{R}ₓ^{†} applied to the qubit, followed by a third multimode translation \hat{T} applied to the bosonic modes. Initially, the ancilla may be prepared in a superposition state (|g [symbol] +|e [symbol] )/\sqrt{2} as represented by |+ [symbol] in the drawing. Moreover, the state of the ancilla may be reset to its ground state |g [symbol] subsequent to the final translation drive.

As a result, each dissipator circuit applies a conditional translation based on one of the stabilizer generators sⱼ, for which various options are described below. For each of the lattice code choices described (e.g., the tesseract code), the same dissipator circuit can be applied, since the choice of lattice code dictates the values of sⱼ, which are part of the dissipator circuit.

In particular, the dissipator circuit includes a symmetrized controlled multimode translation,

$$C \hat{T} ( v ) = {e}^{i \frac{{\hat{σ}}_{z}}{2} l {\hat{x}}^{T} Ω v}$$

which effects a translation in phase space by ±v/2 if the ancilla is in |g [symbol] (the ground state) or |e [symbol] (the first excited state), respectively. The C in front of the translation is used to indicate that the translation is controlled; specifically, that the translation is +v/2 when the ancilla is in |g [symbol] and −v/2 when the ancilla is in |e [symbol] . The translation operation, as described further below, also imparts a phase onto the ancilla qubit.

This type of multimode translation operation can be realized by using a qubit coupled dispersively to multiple modes. For example, consider the Hamiltonian for bosonic modes coupled to an ancilla qubit:

$$\hat{H} = {\sum }_{j = 1}^{m} [ \frac{{χ}_{j}}{2} {\hat{a}}_{j}^{†} {\hat{a}}_{j} {\hat{σ}}_{z} + {ε}_{j} ( t ) {\hat{a}}_{j}^{†} + {ε}_{j}^{*} ( t ) {\hat{a}}_{j} ]$$

with χⱼ the dispersive interaction between the jth mode and the ancilla, and εⱼ(t) the classical drive applied to the jth mode. The classical drives {εⱼ} displace the state of the different oscillators, which then rotate in different directions depending on the state of the ancilla. With suitable echo pulses, this strategy can be used to generate any controlled translation. The controlled displacement rate in each mode depends on the drive amplitude and the dispersive shift, χⱼεⱼ, such that this type of interaction can be implemented in systems with small dispersive coupling by considering strong drives. Moreover, the drive amplitude in each mode can be independently adjusted, and the dispersive shifts of the ancilla qubit to each mode need not be matched. Finally, there is no specific restriction on the oscillator mode frequencies.

Multimode controlled translations can also be implemented in other platforms such as in the motional modes of trapped ions. In this architecture, controlled translations are generated by a laser which activates a state-dependent force. Multiple state-dependent forces in different modes can then be activated using multiple lasers, a type of interaction which has already been realized in the context of (ion-ion) multi-qubit gates.

Returning to FIGS. 6A-6C, the first two translations of each dissipator circuit shown in FIGS. 6A and 6B may be considered to measure the state of the multimode bosonic system along the relevant stabilizer generator vector and to impart a phase to the ancilla qubit based on this state, whereas the third translation of each dissipator circuit corrects the state of the multimode bosonic system based on the state of the ancilla qubit. The second qubit rotations \hat{R}ₓ^{†} have the effect of transforming the phase of the ancilla qubits into population information (that is, produce a superposition of states that reflect the phase). This rotation allows the last controlled translation operation to correct any ancilla qubit and/or multimode errors that may have occurred based on the population state of the ancilla qubit.

In terms of ancilla qubit decay errors during a controlled translation, these result in an effective rotation and translation:

C\hat{T}ₑᵣᵣ=\hat{σ}ᵢₑᵣᵣ\hat{T}[e]Πⱼ\hat{R}ⱼ(φⱼ),

where the rotation in each mode is upper bounded by |φⱼ|≤|χⱼT| with T the interaction time and ierr=±. The translation error \hat{T}(e) occurs on a line parametrized by the time of the error, tₑᵣᵣ ∈[0,T]. In the limit where the dispersive coupling is small, χⱼ→0, and where the controlled translation is generated in a straight line, the rotation error disappears and the translation error is colinear with the desired translation, e=ηsⱼ with a ratio η∈[0,1/2]. The rotation error can also be reduced by considering more than one echo pulse during the controlled translation. To simplify the analysis below, it is assumed that ancilla errors are given by bit flips rather than qubit decay, propagating as errors of the form e=ηsⱼ with η∈[0,1].

For the dissipation circuit of FIG. 6A, the middle controlled translation leaves the state of the bosonic mode effectively displaced by ±sⱼ/2. For a single-mode QEC grid code, this effectively applies a logical Pauli operation, but in general it leaves the state outside of the code space. To recover the original subspace, the state is steered towards the −1 eigenspace of the corresponding stabilizer. As shown in FIGS. 6A, this is achieved by changing the sign of the last small controlled translation using the gauge vⱼ=(−1)^{μ}^{ⱼ}.

A rotation of the qubit Rₓ(θ) is given by:

$${R}_{x} ( θ ) = ( \begin{matrix}cos ( θ / 2 ) & - i sin ( θ / 2 ) \\ - i sin ( θ / 2 ) & cos ( θ / 2 )\end{matrix} )$$

and may be performed by directing a suitable drive to the ancilla qubit.

### Multimode Controlled Translations

As described above, the dissipator circuit includes a symmetrized controlled multimode translation,

$$C \hat{T} ( v ) = {e}^{i \frac{{\hat{σ}}_{z}}{2} l {\hat{x}}^{T} Ω v}$$

which effects a translation in phase space by ±v/2 if the ancilla is in |g [symbol] (the ground state) or |e [symbol] (the first excited state), respectively. This section described how to realize this controlled translation in multiple bosonic modes.

Consider a single qubit coupled to multiple modes via a pairwise dispersive interaction, with a drive εⱼ(t) on each mode, in the Hamiltonian given above:

$$\hat{H} ( t ) = {\sum }_{j} [ \frac{{χ}_{j}}{2} {\hat{a}}_{j}^{†} {\hat{a}}_{j} {\hat{σ}}_{z} + {ε}_{j} ( t ) {\hat{a}}_{j}^{†} + {ε}_{j}^{*} ( t ) {\hat{a}}_{j} ] .$$

This Hamiltonian generates displacements, but also imparts a phase to the ancilla qubit and a qubit state-dependent rotation of the bosonic modes. In order to echo out the ancilla-dependent rotation due to the dispersive shift, consider an evolution in K steps with a qubit flip between each step:

$$\hat{U} = {\prod }_{k = 1}^{K} {\hat{σ}}_{x} 𝒯 {e}^{- i {\int }_{k , i}^{{t}_{k , f}} d τ \hat{H} ( τ )} ,$$

where the kth step is defined ranging from t_{k,i} to t_{k,f} and the product is time-ordered. The final qubit flip is omitted if K is odd. Commute through the qubit flips \hat{σ}ₓ such that, during the kth step, the sign of \hat{σ}_{z} is multiplied by zₖ ∈{±1} which may be included in a continuous function z(t).

With this simplification, the whole evolution can be written in a single step, Û= [symbol] e^{-i∫}^{₀}^{^{T}}^{dτĤ}^{_{z}}^{(τ)}, with

$$\begin{matrix}{\hat{H}}_{z} ( t ) = {\sum }_{j} [ \frac{{χ}_{j}}{2} {\hat{a}}_{j}^{†} {\hat{a}}_{j} {\hat{σ}}_{z} z ( t ) + {ε}_{j} ( t ) {\hat{a}}_{j}^{†} + {ε}_{j}^{*} ( t ) {\hat{a}}_{j} ] , \\ = \frac{\vec{χ} \cdot \vec{\hat{n}}}{2} {\hat{σ}}_{z} z ( t ) + {\vec{\hat{a}}}^{†} \cdot \vec{ε} + {\vec{ε}}^{*} \cdot \vec{\hat{a}} .\end{matrix}$$

Considering the form of the Hamiltonian, take an ansatz for the resulting unitary

$$\hat{U} = {e}^{i θ \frac{{\hat{σ}}_{z}}{2}} {e}^{{\vec{\hat{a}}}^{†} \cdot ( \vec{γ} + \vec{δ} {\hat{σ}}_{z} ) - ( {γ}^{\to †} + {δ}^{\to †} {\hat{σ}}_{z} ) \cdot \vec{\hat{a}}} {e}^{- i \vec{ϕ} \cdot \vec{\hat{n}} {\hat{σ}}_{z}} ,$$

where θ sets the ancilla qubit phase, \vec{ϕ}∈ [symbol] ^{m} represents the qubit-dependent rotation of each mode and \vec{γ}, \vec{δ}∈ [symbol] ^{m} represent the displacement and controlled-displacement of each mode, respectively. Extract a differential equation for each parameters using Schrödinger's equation, \dot{Û}=−iĤ_{z}(t)Û. Neglecting terms leading to an irrelevant global phase, obtain:

$$\dot{θ} = - 2 Re [ {\vec{ε}}^{*} \cdot \vec{δ} ] ,$$

$${\dot{γ}}_{j} = - i \frac{{χ}_{j}}{2} z ( t ) {δ}_{j} - i {ε}_{j} ,$$

$${\dot{δ}}_{j} = - i \frac{{χ}_{j}}{2} z ( t ) {γ}_{j} ,$$

$${\dot{ϕ}}_{j} = \frac{{χ}_{j}}{2} z ( t )$$

In order to echo out the qubit state-dependent rotation of the oscillators, choose a z(t) such that ϕ̅(T)=0. The differential equations above can be solved to yield the parameters

$$θ ( t ) = - 2 {\int }_{0}^{t} d τ Re [ \vec{ϵ} {( τ )}^{*} \cdot \vec{δ} ( τ ) ] ,$$

$${γ}_{j} ( t ) = - i {\int }_{0}^{t} d τcos [ {ϕ}_{j} ( τ ) - {ϕ}_{j} ( t ) ] {ε}_{j} ( τ ) ,$$

$${δ}_{j} ( t ) = {\int }_{0}^{t} d τsin [ {ϕ}_{j} ( τ ) - {ϕ}_{j} ( t ) ] {ε}_{j} ( τ ) ,$$

$${ϕ}_{j} ( t ) = \frac{{χ}_{j}}{2} {\int }_{0}^{t} d τ z ( τ ) ,$$

Using the Baker-Campbell-Hausdorff (BCH) formula to separate the overall and controlled translations, rewrite the resulting unitary as

$$\hat{U} = {e}^{i {θ}^{′} \frac{{\hat{σ}}_{z}}{2}} \times \hat{T} ( \vec{g} ) \times C \hat{T} ( \vec{d} ) ,$$

where \vec{g}, \vec{d}∈ [symbol] ^{2m} as \vec{g}=Vec[\vec{γ}(T)] and \vec{d}=Vec[2\vec{δ}(T)] with Vec[\vec{v}]=\sqrt{2}/l×Re[\vec{v}]⊕Im[\vec{v}]. The (exact) BCH expansion term yields a correction to the phase

$${θ}^{′} = θ + 2 Im [ {\vec{γ}}^{†} \cdot \vec{δ} ] .$$

The desired controlled translation is therefore obtained by applying the drives {εⱼ}, with a displacement and a qubit phase correction at the end. Alternatively, the drives may be chosen such that \vec{γ}(T)=\vec{0} and θ(T)=0. For example, to obtain a controlled translation C\hat{T}(\vec{b}), the evolution can be split into two parts and the drives selected as:

$${ε}_{j} ( t ) = {α}_{d , j} [ δ ( t ) - 2 δ ( t - T / 2 ) cos ( {χ}_{j} T / 4 ) + δ ( t - T ) cos ( {χ}_{j} T / 2 ) ] ,$$

$${α}_{d , j} = {[ C \vec{b} ]}_{j} \frac{l}{2 sin ( {χ}_{j} T / 2 )} ,$$

where δ(t) is the Dirac delta function. This drive can approximately be realized in a system where the displacements by α_{d,j} can be effected in a time scale much faster than 1/χⱼ.

Having described the process for autonomous error correction, examples of various lattice codes will be described below.

### Hypercubic Lattice Code

The simplest multimode lattice is the hypercubic lattice Λ= [symbol] ^{2m}, with generator matrix S= [symbol] ₂ₘ for which det(Λ₀)=1. According to Eqn. 4, valid encodings can be obtained by scaling the hypercubic lattice are of dimension a^{m}, which is equivalent to encoding m qudits of dimension a. In this situation, the generators become S=\sqrt{a} [symbol] ₂ₘ, with the dual lattice given by S*=−Ω/\sqrt{a}.

One approach to quantum computing based on QEC grid code states is to concatenate the hypercubic lattice code encoding m qubits with another qubit code. In this approach, the information is discretized at the single-mode level, and the upper level code is mostly treated as a standard qubit code, potentially incorporating the continuous nature of the single-mode error syndromes to improve the decoding procedure.

However, it may be noted that in this concatenated construction, the logical qubit is not defined by a hypercubic lattice. In two modes, it is possible to encode a single hypercubic qubit using the basis

$${S}_{tess} = \sqrt[4]{2} ( \begin{matrix}1 & 0 & 0 & 0 \\ 0 & \frac{1}{\sqrt{2}} & 0 & \frac{1}{\sqrt{2}} \\ 0 & 0 & 1 & 0 \\ 0 & \frac{1}{\sqrt{2}} & 0 & - \frac{1}{\sqrt{2}}\end{matrix} )$$

which is related to [symbol] ₄ by a scaling factor

$$\sqrt[4]{2}$$

and a rotation by π/4 in the p₁, p₂ plane, a non-symplectic transformation. That QEC grid code is referred to herein as the tesseract code, which has logical operators of length

$$\sqrt[4]{2}$$

times larger than than the single-mode square code. From the intuition of the Gaussian translation error model, this code is therefore more robust than the square code against errors.

Beyond the encoding of a qubit, d=2, all code dimensions that can be expressed as the sum of three squares

$$d = {a}^{2} + {b}^{2} + {c}^{2} ,$$

for a, b, c∈ [symbol] , can be implemented as a two-mode hypercubic code. Legendre's three-square theorem specifies which numbers cannot be written as a sum of three squares. Applied to the above, there exists codes of all dimensions that cannot be written as d=4^{f}(8g+7) for f, g non-negative integers. All hypercubic codes of size d≤20 are therefore possible except for d=7,15.

### Tesseract Lattice Code

The tesseract code is based on a four-dimensional hypercubic lattice, such that the stabilizer generators are all of equal length,

$$\vert {s}_{j} \vert = \sqrt[4]{2}$$

for all j, and are all orthogonal to each other, sⱼ·sₖ=0 for j≠k. As illustrated in FIG. 5B, the base representative of the logical Pauli operators for the tesseract code are chosen as:

$${L}_{0 , tess} = ( \begin{matrix}{x}_{0} \\ {y}_{0} \\ {z}_{0}\end{matrix} ) = \sqrt[4]{2} ( \begin{matrix}1 / 2 & 0 & 1 / 2 & 0 \\ 1 / 2 & 1 / \sqrt{2} & 1 / 2 & 0 \\ 0 & 1 / \sqrt{2} & 0 & 0\end{matrix} ) \qquad ( Eqn . 8 )$$

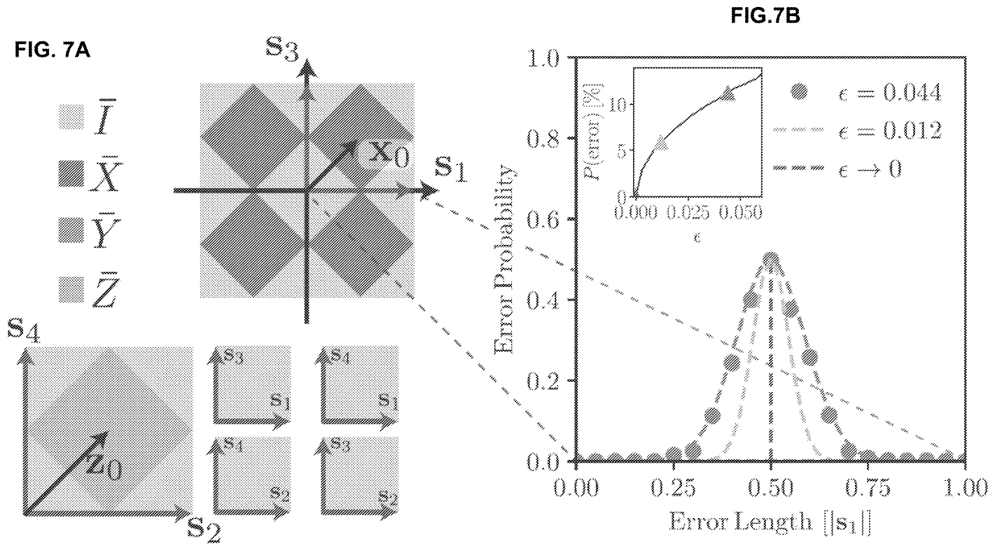

The Y̅ operator of the tesseract code has a length \sqrt{2} larger than the X̅, Z̅ operators. An important distinction between the tesseract code and some single-mode grid codes is that logical operators of the tesseract code are not colinear with a stabilizer vector. More precisely, x₀=(s₁+s₃)/2, z₀=(s₂+s₄)/2 and y₀=(s₁+s₂+s₃+s₄)/2, as illustrated in FIGS. 5A-5B and in FIG. 7A. This may be contrasted with single-mode codes in which x₀=s₁/2, z₀=s₂/2 and y₀=(s₁+s₂)/2.

With the choice of Pauli operators given by Eqn. 8, the logical +Z̅ eigenstate is given by the separable state

$${\vert + \overline{Z} 〉 = \vert {∅}_{\sqrt[4]{2}} 〉}^{⊗ 2} .$$

The logical −Z̅ eigenstate is given by the same tensor product of qunaught states, but choosing a mixed gauge μ=(0,1) for both modes. While Eqn. 8 is derived based on the base Z̅ representative having support only on the first mode, an equivalent representative has support only in the second mode,

$${z}^{′} = \sqrt[4]{2} ( 0 , 0 , 0 , 1 / \sqrt{2} ) .$$

In particular, a measurement in the Z̅ basis can be performed by accessing a single one of either mode comprising the tesseract code. Alternatively, both representatives can be measured to implement a two-bit repetition code to mitigate the effect of different faults such as oscillator errors, measurement errors or ancilla decay during the measurements. Since z₀ and z′ have support on different modes, faults in one measurement do not affect the other.

FIGS. 7A-7B depict the effect of translation errors in the tesseract code, according to some embodiments. In particular, FIG. 7A depicts logical operations applied as a function of the initial translation error given by span(sⱼ,sₖ). FIG. 7B depicts the logical error probability as a function of the length of a translation error along s₁. The full quantum model (dots) is compared with the classical model (dashed line). The inset of FIG. 7B shows the integrated logical error probability given that an error ηs₁ occurred, with η sampled uniformly in the interval [0,1].

### D₄ Lattice Code

The D₄ lattice code is a two-mode QEC grid code based on the D₄ lattice, which allows the densest lattice packing in four dimensions. This particular code has several interesting features, particularly with respect to logical operations. Indeed, in contrast to the tesseract code, all single qubit Clifford gates can be performed with passive gaussian operations (envelope-preserving gates). The D₄ code also allows exact non-Clifford gates through envelope-preserving Kerr-type interactions.

In a similar fashion to a 3-dimensional hexagonal close-packed lattice which can be built by stacking layers of two-dimensional honeycombs lattices (stacking oranges), the D₄ lattice can be built by “stacking” layers of 3-dimensional body-centered cubic lattices in the fourth dimension.

Choosing a set of generators which all have support on both modes, it may be desirable to set:

$${S}_{{D}_{4}} = ( \begin{matrix}1 & 0 & 1 & 0 \\ 1 & 0 & 0 & - 1 \\ 0 & 1 & - 1 & 0 \\ 1 & 0 & 0 & 1\end{matrix} ) .$$

However, this choice is not unique since the D₄ lattice has 12 vectors of minimal length (not counting those that differ only by a sign). The base representatives of the logical operators are chosen to be

$${L}_{0 , {D}_{4}} = ( \begin{matrix}{x}_{0} \\ {y}_{0} \\ {z}_{0}\end{matrix} ) = ( \begin{matrix}1 / 2 & 1 / 2 & 1 / 2 & 1 / 2 \\ - 1 / 2 & 1 / 2 & 1 / 2 & 1 / 2 \\ 1 & 0 & 0 & 0\end{matrix} ) .$$

Similar to the stabilizers, this choice is not unique and for each logical Pauli operator there are 4 equivalent representatives of minimum length (not counting those that differ only by a sign). For example, the Z̅ logical operator can be represented as z=(±1,0,0,0); (0, ±1,0,0); (0,0, ±1,0) or (0,0,0, ±1), such that Z̅ eigenstates can be described as hypercubic qunaught states S_{Z}= [symbol] ₄=S_{ø}^{⊕2}. In the trivial gauge μ=0 and with the choice of basis given by S_{D}_{₄} above:

$${\vert \pm \overline{Z} 〉 = \vert \pm ∅ 〉}^{⊗ 2} ,$$

with |ø [symbol] the single-mode square qunaught state. The “negative” qunaught state |−ø [symbol] has also been defined as the −1 eigenstate of the translation operators associated to the generators of S_{ø}, i.e. the square qunaught state with gauge μ=(1,1). As in the tesseract code, both code words are separable states of the two modes, and as a result can be prepared in independent modes.

Measurements in the Z̅ basis of the D₄ code can be performed in both modes separately, yielding a simple two-bit repetition code that can allow the detection of one measurement error. In principle, all four orthogonal representatives may be measured and a majority vote taken to determine the most likely measurement result. However, in this case all measurement are not independent as, for example, an ancilla decay error during the z=(1,0,0,0) measurement can propagate as a measurement error in the z=(0,1,0,0) measurement.

Due to the four-fold rotation symmetry of the qunaught states, they have a definite excitation number modulo four, and they can be expressed in the Fock number basis as

$$\vert + ∅ 〉 = {\sum }_{j} {c}_{j +} \vert 4 j 〉 , \\ \vert - ∅ 〉 = {\sum }_{j} {c}_{j -} \vert 4 j + 1 〉 .$$

The fact that n=0 mod 4 for the positive qunaught state can be computed by directly applying the rotation operator to the state. By expressing the negative qunaught state as a translated positive qunaught state, obtain:

$$\begin{matrix}{e}^{i \frac{π}{2} \hat{n}} \vert - ∅ 〉 = {e}^{i \frac{π}{2} \hat{n}} \hat{T} [ ( 1 / 2 ; 1 / 2 ) ] \vert + ∅ 〉 \\ = \hat{T} [ ( - 1 / 2 ; 1 / 2 ) ] \vert + ∅ 〉 \\ = {e}^{i \frac{π}{2}} \hat{T} [ ( 1 / 2 ; 1 / 2 ) ] \hat{T} [ ( - 1 ; 0 ) ] \vert + ∅ 〉 \\ = {e}^{i \frac{π}{2}} \vert - ∅ 〉\end{matrix}$$

which implies that |−ø [symbol] has support only on Fock states n=1 mod 4. Importantly, since the envelope does not change the excitation number, this is also true for finite-energy states.

In contrast to single-mode QEC grid codes, the two finite-energy code words of the D₄ code are exactly orthogonal. However, this orthogonality has limited usefulness in practice, as logical measurements of the code words are performed through (controlled) translations which do not allow perfect distinguishability. In principle, one could perform logical measurement through excitation number measurements in a similar fashion to logical measurement of cat codes. However, this type of measurement is less robust against oscillator errors such as photon loss. Moreover, the distinguishability limit for QEC grid codes is much smaller than typical errors induced by practical measurement circuits, such that measurement of translation properties are expected to remain optimal.

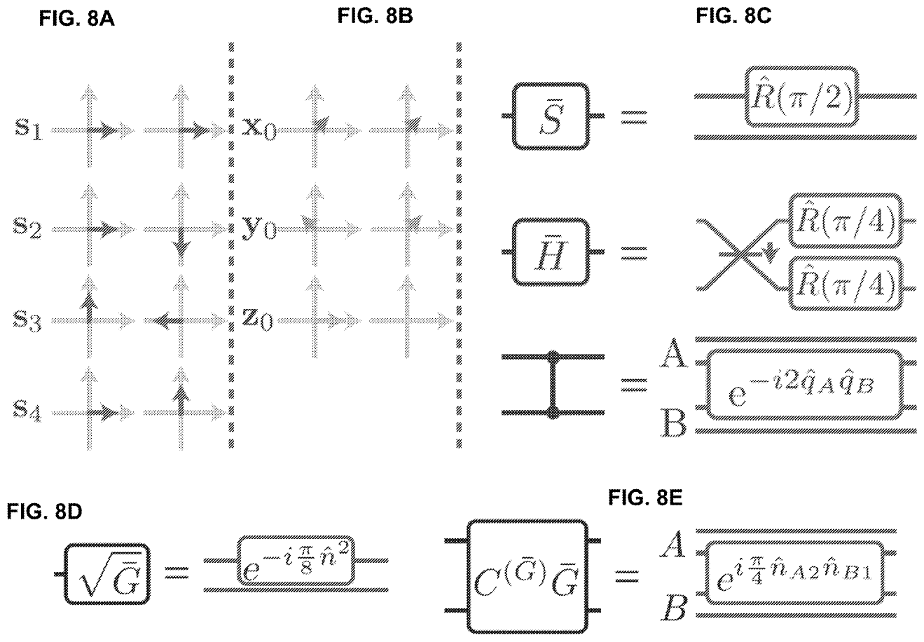

FIG. 8A depicts the phase space representation of the stabilizer generators of the D₄ lattice grid code. The left and right graphs of FIG. 8A represent the projection onto the (q,p) phase space of the first and second mode, respectively. FIG. 8B depicts a similar representation for the logical operators of the D₄ lattice grid code.

FIG. 8C depicts logical Clifford operations in the D₄ code. In particular, the S̅ gate can be effected by a π/2 rotation in either mode, with a rotation in the first mode represented. The H̅ gate is implemented by a beamsplitter followed by a rotation of π/4 in both modes. The logical CZ̅ gate is implemented by a resealed SUM gate. This gate may be represented as an operation between the second mode of A and the first mode of B, but choosing any pair of modes from the codes A and B is equivalent. FIG. 8D depicts a non-Clifford \sqrt{G̅} logical gate, with G̅=X̅S̅=(X̅+Y̅)/\sqrt{2}. A Kerr gate in either mode realizes this logical operation. FIG. 8E depicts a non-Clifford G̅-controlled G̅ logical gate, which can be realized by a cross-Kerr gate involving any pair of mode from the two D₄ codes.

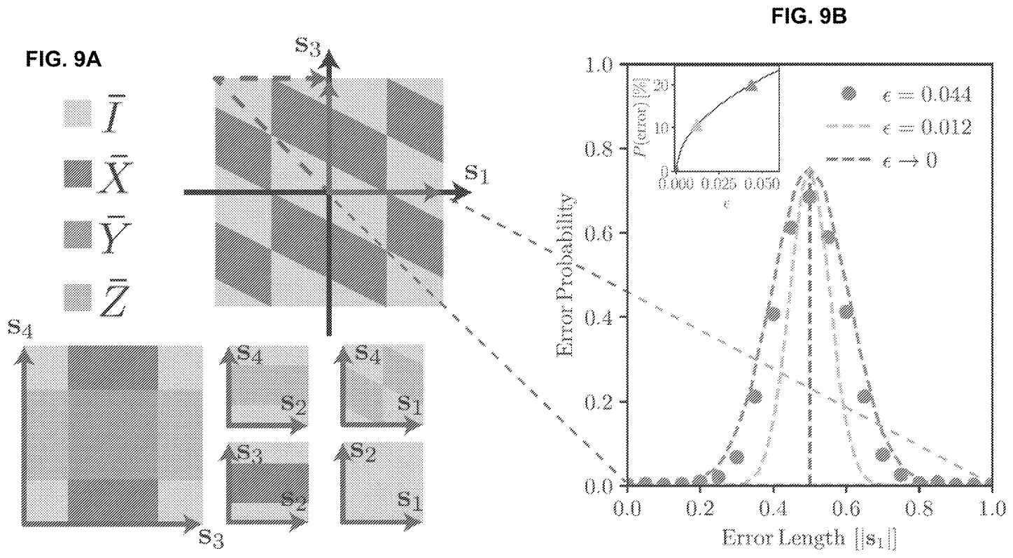

FIG. 9A depicts the effect of translation errors in the D₄ code, with logical operations applied as a function of the initial translation error in the planes given by span(sⱼ, sₖ). FIG. 9B depicts the logical error probability as a function of the length of a translation error along s₁. The full quantum model (dots) is compared with the classical model (dashed lines) The inset of FIG. 9B shows the integrated logical error probability given that an error ηs₁ occurred, with η sampled uniformly.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a circuit quantum electrodynamics system that includes an ancilla qubit dispersively coupled to a multimode bosonic system having a plurality of modes and operating as a logical qubit, the method comprising:
repeatedly performing a sequence of operations that autonomously detect and correct quantum errors arising in the state of the ancilla qubit and/or in the state of the logical qubit, the sequence of operations comprising:
applying a first drive waveform to each of the plurality of modes of the multimode bosonic system, wherein the first drive waveform changes the state of the ancilla qubit dependent on whether an error has occurred in the state of the ancilla qubit and/or in the state of the logical qubit;
subsequent to applying the first drive waveform, applying a second drive waveform to the ancilla qubit; and
subsequent to applying the second drive waveform, applying a third drive waveform to each of the plurality of modes of the multimode bosonic system, wherein the third drive waveform corrects the error that occurred in the state of the ancilla qubit and/or in the state of the logical qubit.

2. The method of claim 1, wherein the sequence of operations further comprises:
applying a fourth drive waveform to each of the plurality of modes of the multimode bosonic system, wherein the fourth drive waveform changes the state of the ancilla qubit dependent on whether an error has occurred in the state of the ancilla qubit;
subsequent to applying the fourth drive waveform, applying a fifth drive waveform to the ancilla qubit.

3. The method of claim 1, wherein the sequence of operations further comprises applying a sixth drive waveform to the ancilla qubit to drive the ancilla qubit into an excited state.

4. The method of claim 1, wherein the multimode bosonic system comprises a plurality of distinct bosonic systems each having one or more modes.

5. The method of claim 1, wherein the multimode bosonic system comprises a single bosonic system having a plurality of modes.

6. The method of claim 1, wherein the ancilla qubit is a transmon qubit.

7. The method of claim 1, wherein the multimode bosonic system comprises two microwave cavities coupled to the ancilla qubit.

8. The method of claim 1, wherein the sequence of operations autonomously detect and correct quantum errors arising in the state of the ancilla qubit, and wherein the first drive waveform changes the state of the ancilla qubit dependent on whether an error has occurred in the state of the logical qubit.

9. The method of claim 1, further comprising performing a plurality of quantum gates on a logical state of the logical qubit.

10. The method of claim 9, wherein the plurality of quantum gates are performed interleaved with instances of the sequence of operations, such that the method comprises at least performing a first quantum gate, followed by performing the sequence of operations a first time, followed by performing a second quantum gate, followed by performing the sequence of operations a second time.

11. The method of claim 1, wherein the first drive waveform changes the state of the ancilla qubit by imparting a change of phase to the state of the ancilla qubit.

12. The method of claim 1, wherein the first drive waveform further changes the state of one or more modes of the multimode bosonic system.

13. A system, comprising:
a circuit quantum electrodynamics system that includes an ancilla qubit dispersively coupled to a multimode bosonic system having a plurality of modes and operating as a logical qubit;
at least one computer readable medium storing a plurality of drive waveforms;
at least one controller configured to:
apply a first drive waveform of the plurality of waveforms to each of the plurality of modes of the multimode bosonic system, wherein the first drive waveform changes the state of the ancilla qubit dependent on whether an error has occurred in the state of the ancilla qubit;
subsequent to applying the first drive waveform, apply a second drive waveform of the plurality of waveforms to the ancilla qubit; and
subsequent to applying the second drive waveform, apply a third drive waveform of the plurality of waveforms to each of the plurality of modes of the multimode bosonic system, wherein the third drive waveform corrects the error that occurred in the state of the ancilla qubit.

14. The system of claim 13, wherein the multimode bosonic system comprises a plurality of distinct bosonic systems each having one or more modes.

15. The system of claim 13, wherein the multimode bosonic system comprises a single bosonic system having a plurality of modes.

16. The system of claim 13, wherein the ancilla qubit is a transmon qubit.

17. The system of claim 13, wherein the multimode bosonic system comprises two microwave cavities coupled to the ancilla qubit.

18. The system of claim 13, wherein the at least one controller is further configured to:
apply a fourth drive waveform to each of the plurality of modes of the multimode bosonic system, wherein the fourth drive waveform changes the state of the ancilla qubit dependent on whether an error has occurred in the state of the ancilla qubit;
subsequent to applying the fourth drive waveform, apply a fifth drive waveform to the ancilla qubit.

19. The system of claim 13, wherein the at least one controller is further configured to apply a sixth drive waveform to the ancilla qubit to drive the ancilla qubit into an excited state.

20. The system of claim 13, wherein the first drive waveform changes the state of the ancilla qubit by imparting a change of phase to the state of the ancilla qubit.
